(19) United States
(12) Patent Application Publication
(10) Pub. No.: US 2011/0220733 A1
(43) Pub. Date: Sep. 15, 2011

(54) CREMATED REMAINS SCATTERING APPARATUS

(76) Inventors: Kris K. Larson, Fullerton, CA (US); Jamie Parel Tanabe, La Habra Heights, CA (US)

(21) Appl. No.: 13/034,988

(22) Filed: Feb. 25, 2011

Related U.S. Application Data
(60) Provisional application No. 61/340,201, filed on Mar. 15, 2010.

(51) Int. Cl. B05B 15/00

(52) U.S. Cl. 239/10; 239/722

(57) ABSTRACT

The present invention generally relates to an apparatus for scattering cremated remains. More particularly, the invention relates to an apparatus that is used in conjunction with a vehicle, most commonly an aircraft, that allows for the dispersal of cremated remains of a deceased individual in a safe and clean manner that preserves the dignity of the deceased.

### CROSS REFERENCE TO RELATED APPLICATIONS

This application claims the benefit of U.S. Provisional Patent Application No. 61/340,201 Filed Mar. 15, 2010, the entire disclosure of which is incorporated herein by reference.

### FIELD OF THE INVENTION

The present invention generally relates to an apparatus for scattering cremated remains. More particularly, the invention relates to an apparatus that is used in conjunction with a vehicle, most commonly an aircraft that allows for the dispersal of cremated remains of a deceased individual in a safe and clean manner that preserves the dignity of the deceased.

### BACKGROUND OF THE INVENTION

Cremation has become a popular option for handling the remains of loved ones after they have died. Once cremated, the executors of the deceased individual's estate or the heirs typically are required to make a decision of how to best handle the remains, in accordance with the wishes of the deceased.

One popular method of handling the cremated remains of a deceased individual is to have them aerially dispersed via a vehicle travelling at speeds such that the remains are evacuated from a container that houses the remains. This is typically done in or over a location or geographic feature that was particularly important to the deceased individual during their lifetime. For instance, individuals who had a passion for the oceans during their lifetime may desire to have their ashes scattered over an ocean via a plane.

Devices currently in use to hold and scatter the remains over a given area have several drawbacks and limitations. For instance, one commonly used approach is to simply open the window of an aircraft in flight and empty the contents of an urn containing the cremated remains of the deceased individual. This method has several serious drawbacks, including the fact that, due to air flow patterns caused by open aircraft windows, a portion of the remains are scattered inside the aircraft. Additionally, this method can also create a severe safety issue as cremated remains are very abrasive can damage the aircraft, not unlike sandblasting. This is unsanitary, unsafe and does not preserve the integrity and dignity of the remains of the deceased.

Another method for scattering the cremated remains of a deceased individual is shown in U.S. Pat. No. 4,877,203, to Harden, issued on Oct. 31, 1989 (Hereinafter, “Harden”). In Harden, two methods are disclosed for the scattering of the cremated remains of a deceased individual. The first method of Harden entails using a sealable container partially exposed through a window common on some aircraft. The second method of Harden is to use an apparatus made of fabric that is rolled up like a sleeping bag and then unrolled through an open airplane window during flight.

The first method of Harden has several limitations. First, this method is limited to use on aircraft with a small window that may be adapted to receive the device. Second, the shape and direction of the device is such that airflow in and around the device is not directed in a manner that guarantees proper dispersal of the remains. Finally, since the device is located in such close proximity to the plane, there is a good chance that some of the remains will be dispersed along one or more sides of the aircraft itself and/or damage the aircraft. This method releases the cremated remains directly into the boundary layer (a layer of turbulent air next to plane) which causes the cremated remains to follow the curvature of the airframe and will likely deposit some of the cremated remains on the aircraft and possibly damage the aircraft.

The second method of Harden is limited in several similar fashions. First, the fabric device is not rigid, and as such, when it is unrolled out the window of a moving aircraft, the device may not be stable and may bounce around in an unsafe manner. Second, since the device is held in a hand of the pilot or passenger of the aircraft, there is the distinct possibility that the device may be accidentally dropped from the window of the aircraft, resulting in dangerous conditions to those inside and outside of the aircraft. There is also the possibility that, if dropped, the apparatus will not properly disperse the remains of the cremated individual.

Therefore, there is a need in the art for an apparatus that provides for the safe, clean and convenient dispersal of cremated remains in a manner that also preserves the dignity of the deceased.

### SUMMARY OF THE INVENTION

The present invention relates to the scattering of the cremated remains of a deceased individual. According to an embodiment of the present invention, an apparatus is provided which disperses the cremated remains of the deceased individual in a clean, safe and convenient manner that also preserves the dignity of the deceased individual.

According to an embodiment of the present invention, the apparatus is comprised of a cremated remains dispersal tube with one specially shaped end and the other end being attached to a cremated remain receiver. The cremated remains dispersal tube is hollow and of a length such that the specially shaped end may extend out of an opening on a vehicle far enough such that when cremated remains pass through the tube, the cremated remains are dispersed into the air in such a manner that little or no cremated remains are blown onto or into the vehicle.

According to an embodiment of the present invention, a cremated remains dispersal tube may be comprised of a body portion that is collapsible. For instance, the body portion of a cremated remains dispersal tube may be comprised of a telescoping tube that retracts into a compressed form factor for easy transportation and extends into a long form factor for dispersal of cremated remains.

According to an embodiment of the present invention, a cremated remain receiver is a hollow tube with a large open end for receiving cremated remains, a narrowing middle body portion and a narrow end for connecting to a cremated remains dispersal tube.

According to an embodiment of the present invention, in operation, a cremated remains scattering apparatus described herein is carried inside a vehicle transporting the cremated remains of one or more individuals. Once at the proper location and speed, the cremated remains dispersal tube is extended from an opening on the vehicle. Due to the specially shaped end on the cremated remains dispersal tube, suction begins to form, creating an airflow from the end of the tube connected to the cremated remains receiver towards the shaped end. At this point, cremated remains may be poured into the large open end of the cremated remain receiver. The suction previously created will suck the cremated remains through the cremated remain receiver into the cremated remains dispersal tube and then out into the environment outside of the vehicle.

The foregoing description and summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 depicts an exterior view of an apparatus in accordance with an embodiment of the present invention.

FIG. 2 depicts an interior view of an apparatus in accordance with an embodiment of the present invention.

### DETAILED SPECIFICATION

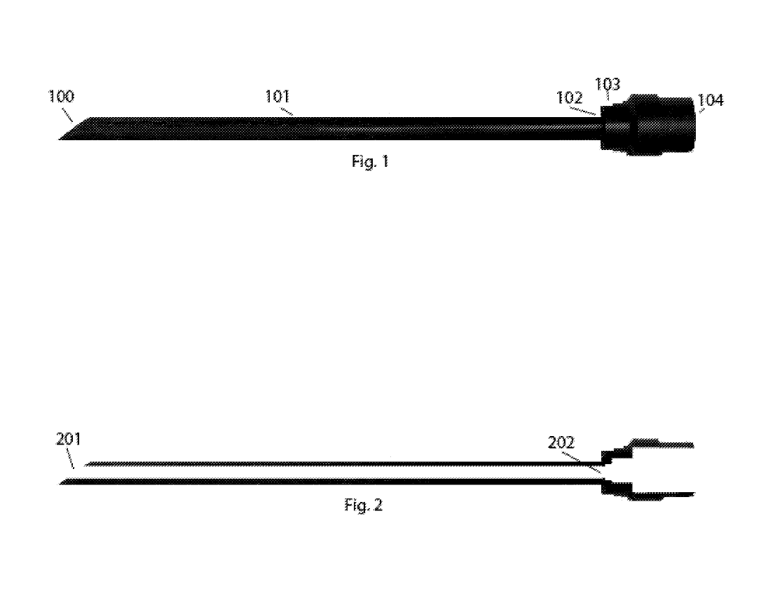

The present invention generally relates to an apparatus for scattering cremated remains. Turning now to FIG. 1, an apparatus is provided, in accordance with an embodiment of the present invention, comprised of a cremated remains dispersal tube and a cremated remains receiver.

According to an embodiment of the present invention, the cremated remains dispersal tube is comprised of a hollow tube portion 101 of such a length that it may be extended from an opening on a vehicle far enough such that the end of the cremated remains dispersal tube extends into a slipstream beyond a boundary layer (i.e., an layer of turbulent air around a vehicle). Extending the cremated remains dispersal tube into the slipstream beyond the boundary layer allows the cremated remains to pass through the tube into the external environment in such a manner that little or no cremated remains are blown onto or into the vehicle. The length of the hollow tube portion 101 will vary depending on the usage, the vehicle and the speeds at which the vehicle will be travelling during dispersal of the cremated remains.

According to an embodiment of the present invention, the cremated remains dispersal tube may be affixed through the opening on a vehicle. For instance, the cremated remains dispersal tube may be affixed to a hole in the floor or side of a vehicle, such as an aircraft. Alternatively, the cremated remains dispersal tube may be carried within, alongside or otherwise unfixed to the vehicle. In this manner, the cremated remains dispersal tube may be extended from an opening on the vehicle as the vehicle nears the location for dispersal of the cremated remains.

According to an embodiment of the present invention, the hollow tube portion 101 may be made from a rigid material that is smooth on the inside cavity, such that cremated remains may flow easily from one end of the tube to the other. For instance, the cremated remains dispersal tube may be constructed from PVC tubing or aluminum. One of ordinary skill in the art would appreciate that there are numerous materials the cremated remains dispersal tube could be made from, and embodiments of the present invention are contemplated for use with any material.

According to another embodiment of the present invention, the hollow tube portion 101 may be made from a material that collapses to a small form factor for easy transportation and extends to a long form factor for the dispersal of cremated remains. For instance, the hollow tube portion 101 may be comprised of a telescoping tube. In another embodiment, the hollow tube portion 101 may be comprised of a tube that has multiple segments, each of which attach to the other segments via a connection means such as a screw in connection or twist-and-lock connection. One of ordinary skill in the art would appreciate there are numerous materials and methods for creating a hollow tube portion 101 which is collapsible, and embodiments of the present invention are contemplated for use with any material or method for creating a collapsible tube.

According to an embodiment of the present invention, the cremated remains dispersal tube is further comprised of a specially shaped end 100. The shape of the specially shaped end 100 allows the apparatus to create suction based upon the velocity of the vehicle the apparatus is being utilized in. For instance, the specially shaped end 100 may be formed in a 45 degree angle. One of ordinary skill in the art would appreciate that the there are numerous angles and shapes that would work to create suction through the specially shaped end 100 of the cremation remains dispersal tube, and embodiment of the present invention are contemplated for use with any angle or shape designed to create suction.

According to an embodiment of the present invention, the cremated remains dispersal tube is further comprised of a connecting end 102. Connection end 102 attaches to the rear end 103 of the cremated remains receiver. The connection end 102 of the cremated remains dispersal tube may connect to the rear end 103 of the cremated remains receiver in numerous ways, including, but not limited to, a welded connection, a screwed connection, an epoxy or other glue connection, or the connection end 102 and the rear end 103 may be connected by heat sealing the two ends together. The connection is made in such a manner as to not impede the flow from the hollow tube portion of the cremated remains dispersal tube and a hollow portion of the cremated remains receiver. One of ordinary skill in the art would appreciate that there are numerous ways to connect the connection end 102 to the rear end 103, and embodiments of the present invention are contemplated for use with any type of connection.

Optionally, a removable or slidable device may be placed between the hollow tube portion of the connection end 102 of the cremated remains dispersal tube or the rear end 103 of the cremated remains receiver. This removable or slidable device allows remains deposited into the cremated remains receiver to stay within the hollow portion of the cremated remains receiver until the removable or slidable device is partially or wholly removed. In this manner, the suction of cremated remains from the cremated remains receiver through the cremated remains dispersal tube to the environment outside of the vehicle does not begin until an operator partially or wholly removes the removable or slidable device. In this embodiment of the invention, a removable lid may be attached to top of the cremated remains receiver to contain the cremated remains along with provisions for venting to allow airflow through the device.

According to an embodiment of the present invention, the cremated remains receiver is comprised of a rear end 103 and a front remains receiving end 104. As previously discussed, the rear end 103 connects to a connection end 102 of the cremated remains dispersal tube. The front remains receiving end 104 allows for the insertion of cremated remains.

In an exemplary embodiment, in accordance with the present invention, cremated remains may be inserted into the front remains receiving end 104 at the desired dispersal location. In this manner, cremated remains of one or more individuals may be fed into the front remains receiving end 104 and sucked through the rear end 103 through the hollow tube portion 101 of cremated remains dispersal tube and out the specially shaped end 100.

In an another embodiment, in accordance with the present invention, cremated remains of one or more individuals may be contained in one or more cremated remains receivers. The rear end 103 of each of the cremated remains receivers may be sealed with a removable or slidable device previously described herein. The front remains receiving end would be sealed with a lid and be vented as previously described herein. In this embodiment, the connection end between the connection end 102 of the cremated remains dispersal tube 102 and rear end 103 of each of the one or more cremated remains receiver would be one of a removable type (e.g., screw-in, snap-on, etc.). In this manner, a cremated remains receiver could be connected to the cremated remains dispersal tube, have the removable or slidable devices removed to allow suction to pull the cremated remains through cremated remains dispersal tube to the environment outside of the vehicle. This process could then be repeated until each of the one or more cremated remains receivers were emptied at one or more desired locations.

Turning now to FIG. 2, the inside of an apparatus in accordance with embodiments of the present invention is shown. An opening 201 at the specially shaped end 100 of a cremated remains dispersal tube is shown. The opening 201 is the area of the apparatus from which cremated remains will exit the apparatus from. Interior connection point 202 shows the interior of the connection between connection end 102 of the cremated remains dispersal tube and rear end 103 of the cremated remains receiver. Interior connection point 202 may be obstructed by a removable or slidable device as previously described. When no removable or slidable device is present, cremated remains may flow from the cremated remains receiver, all the way through the hollow tube portion 101 of the cremated remains dispersal tube and into the environment outside of the vehicle beyond the boundary layer.

According to another embodiment, cremated remains scattering apparatus is disclosed, comprising a cremated remains receiver and a cremated remains dispersal tube. The cremated remains receiver is in the shape of an urn. The urn shaped cremated remains receiver is vented to allow airflow. The connection point between the urn shaped receiver and the body portion or body portion and the dispersal tube will be obstructed by a removable or slidable device, such as a valve, that may be opened to release the remains at the proper location. A body portion of the cremated remains receiver is comprised of a rear end with a hollow portion to allow for the passage of cremated remains from the cremated remains receiver through to the cremated remains dispersal tube.

According to the embodiment of the present invention described in the previous paragraph, the cremated remains receiver and cremated remains dispersal tube are separated by a removable or slidable device. In this embodiment, the removable or slidable device may be, for instance, a slide valve. The slide valve allows for cremated remains to be contained in the cremated remains receiver until the vehicle is in the appropriate location for the dispersal of the cremated remains. Once the vehicle has reached the appropriate location, the slide valve is slid into an open position, allowing suction to form and draw the cremated remains out through the cremated remains dispersal tube.

According to another embodiment, a cremated remains scattering apparatus may be further comprised of a safety tether. In this manner, the safety tether prevents the cremated remains scattering apparatus from coming loose and being drawn out of the vehicle and creating an environment that would be hazardous to the vehicle, vehicle operator and any object or individual in the path of the uncontrolled apparatus. The safety tether may be, for instance, comprised of a cord, rope or stand of material with sufficient tensile strength to resist the pressures applied to the cremated remains scattering apparatus. One end of the safety tether may attach to the cremated remains scattering device. This may be accomplished by attaching one end of the safety tether to a special loop, hook, tie-point or other attachment point located on the exterior the cremated remains scattering device. Alternatively, the safety tether may be threaded around or tied around the exterior of the cremated remains scattering device. A second end of the safety tether may be held by an operator of the cremated remains scattering device or attached to an appropriate fixture on the vehicle.

### Exemplary Embodiment

The following description is of an exemplary embodiment of the present invention. According to this exemplary embodiment, a cremated remains scattering apparatus is provided, comprised of a cremated remains dispersal tube and a cremated remains receiver.

According to this exemplary embodiment, the cremated remains dispersal tube is comprised of specially shaped end 100 to create suction. The cremated remains dispersal tube is further comprised of a hollow tube portion 101, extending from the specially shaped end 100. The cremated remains dispersal tube is further comprised of a connection end 102 extending from opposite end of the hollow tube portion 101 from the specially shaped end 100. In this exemplary embodiment, the cremated remains dispersal tube is 46 inches in length from specially shaped end 100 to connection end 102, with a diameter of 2 inches.

According to this exemplary embodiment, the cremated remains receiver is comprised of a rear end 103, a middle body section and a front remains receiving end 104. The front remains receiving end 104 is comprised of a hollow tube that is 6 inches in length and 4 inches in diameter. The middle body section is a narrowing bell shape that starts at 4 inches in diameter at the end closest to the front remains receiving end 104 and 2 inches in diameter at the end closest to the rear end 103. The rear end 103 is comprised of a hollow tube portion that is 2 inches in diameter.

According to this exemplary embodiment, the rear end 103 of the cremated remains receiver and the connection end 102 of the cremated remains dispersal tube are fixably adjoined with ABS glue. The entire cremated remains scattering apparatus should be approximately 51 inches long.

In an exemplary use case, the cremated remains scattering apparatus previously described would be transported in the interior of an aircraft to a location where one or more cremated remains are intended to be scattered. As the aircraft approaches the desired location and obtains the desired speed, the specially shaped end 100 and hollow tube portion 101 of the cremated remains scattering apparatus would be extended from an opening on the aircraft. Any appropriate opening may be used. For example, the angled end 100 and hollow tube portion 101 may be extended from an opened aircraft door, window or special hole created especially for the cremated remains scattering apparatus. One of ordinary skill in the art would appreciate there are numerous openings that may be used with embodiments of the present invention, and embodiments of the present invention are contemplated for use with any appropriate opening. Additionally, one of ordinary skill in the art would appreciate that there are a wide range of desired speeds (e.g., 90 knots in a Cessna 172 or 182) that may be used with embodiments of the present invention, and embodiments of the present invention are contemplated for use with any range of speeds.

Once extended, a suction will begin to pull from the cremated remains receiver end of the cremated remains scattering apparatus out towards the specially shaped end 100. At this point, an operator may begin inserting cremated remains into the cremated remains receiver. Cremated remains inserted into the cremated remains receiver are suctioned through the cremated remains scattering device and ejected outside of the aircraft at a distance where there is little to no risk of damage to the aircraft or the cremated remains being stuck to the aircraft or being blown back into the cockpit of the aircraft.

It is understood that the above-described embodiments are illustrative of only a few of the many possible specific embodiments, which can represent applications of the invention. Numerous and varied other arrangements can be made by those skilled in the art without departing from the spirit and scope of the invention.

1. A cremated remains scattering apparatus, comprising:
a cremated remains dispersal tube,
wherein said cremated remains dispersal tube is comprised of specially shaped end, a hollow tube portion and a connection end,
wherein said specially shaped end is cut in a shape such that suction is created when said cremated remains dispersal tube is extended from a moving vehicle; and
a cremated remains receiver,
wherein said cremated remains receiver is comprised of a front remains receiving end, a middle body section and a rear end, and
wherein said rear end is connected to said connection end of said cremated remains dispersal tube.

2. The system of claim 1 wherein said connection between said rear end of said cremated remains receiver and said connection end of said cremated remains dispersal tube is removable.

3. The system of claim 1 wherein said hollow tube portion is collapsible.

4. The system of claim 1 wherein said shape of said specially shaped end is a 45 degrees angle.

5. The system of claim 1 wherein said connection between said rear end of said cremated remains receiver and said connection end of said cremated remains dispersal tube is a twist lock.

6. The system of claim 1 wherein said connection between said rear end of said cremated remains receiver and said connection end of said cremated remains dispersal tube is a button lock.

7. The system of claim 1 further comprising a removable device positionable within a hollow portion between said connection between said rear end of said cremated remains receiver and said connection end of said cremated remains dispersal tube.

8. The system of claim 7 wherein said removable device, when positioned within said hollow portion between said connection between said rear end of said cremated remains receiver and said connection end of said cremated remains dispersal tube, prevents the formation of suction.

9. The system of claim 8 wherein said removable device, when positioned within said hollow portion of said front remains receiving end, prevents the formation of suction.

10. The system of claim 1 further comprising a vented lid within a hollow portion of said front remains receiving end.

11. The system of claim 1 further comprising a safety tether attached to the cremated remains dispersal tube.

12. The system of claim 1 further comprising an affixing point on said cremated remains dispersal tube for receiving an end of a safety tether.

13. A method of dispersing cremated remains, the method comprising:
setting a vehicle in between a predefined range of speeds;
extending a first end of a cremated remains scattering apparatus from an opening on said vehicle;
feeding cremated remains into a second end of said cremated remains scattering apparatus,
wherein said second end of said cremated remains scattering apparatus is located within said vehicle;
allowing suction to pull said cremated remains through said second end of said cremated remains scattering apparatus through said first end of said cremated remains scattering apparatus and out into an environment outside of said vehicle;
retracting said first end of said cremated remains scattering apparatus from said opening on said vehicle.
